(19) United States
(12) Patent Application Publication
(10) Pub. No.: US 2004/0248548 A1
(43) Pub. Date: Dec. 9, 2004

(54) Portable terminal and pos terminal

(76) Inventors: Takanori Niwa, Tokyo (JP); Yasutaka Urakawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/488,923

(22) PCT Filed: Oct. 31, 2001
(86) PCT No.: PCT/JP01/09560

(51) Int. Cl. H04M 11/00

(52) U.S. Cl. 455/407

(57) ABSTRACT

In a case where payment is shared by members, the amount of payment per person is calculated and is transmitted to member mobile terminals 1a to 1d and data for account settlement corresponding with the amount of payment is acquired from the member mobile terminals 1a to 1d.

### TECHNICAL FIELD

This invention relates to a mobile terminal and a POS terminal for constructing an electronic account settlement system.

### BACKGROUND ART

In a conventional electronic account settlement system, for example, in a case where payment is shared by members of a group in a restaurant, each of the members needs to operate his own mobile terminal (for example, mobile phone) to make a request to the POS terminal of the shop to go through a procedure of the electronic account settlement.

In addition, in a conventional electronic account settlement system, unless a person who purchases goods operates his own mobile terminal, the person can not make a request to the POS terminal of a shop to go through a procedure of electronic account settlement. Thus, for example, even when a person's friend goes to a department store in a distance on business, the person cannot make a request to the friend to buy some goods but the person himself needs to go to the department store in a distance.

Since the conventional electronic account settlement system is constructed in the above manner, for example, in a case where payment is shared by members of a group, the conventional electronic account settlement system presents a problem that each of the members needs to operate his own mobile terminal to make a request to the POS terminal of the shop to go through a procedure of electronic account settlement, which results in making the procedure of electronic account settlement complicated.

This invention has been made to solve the above problems, and it is the object of this invention to provide a mobile terminal and a POS terminal, which are capable of simplifying the procedure of electronic account settlement.

### DISCLOSURE OF THE INVENTION

According to a mobile terminal in accordance with this invention, data for account settlement acquired by a data acquisition unit is transmitted to a POS terminal to make a request to the POS terminal to go through a procedure of electronic account settlement for a banking agency.

This produces an effect of simplifying the procedure of electronic account settlement.

According to the mobile terminal in accordance with this invention, the data acquisition unit has a short-range wireless communication function of receiving the data for account settlement from other mobile terminals. This produces an effect of acquiring the data for account settlement without troublesome cable connections.

According to the mobile terminal in accordance with this invention, information relating to a banking agency to do business with is added to a certificate prepared by a certificate preparation unit so as to prepare data for account settlement, and the data for account settlement is supplied to other mobile terminal.

This produces an effect of simplifying the procedure of electronic account settlement.

According to the mobile terminal in accordance with this invention, a data supply unit has a short-range wireless communication function of transmitting the data for account settlement to other mobile terminals.

This produces an effect of acquiring the data for account settlement without troublesome cable connections.

According to the mobile terminal in accordance with this invention, the certificate preparation unit describes an upper limit to the amount of payment and an expiration date to allow the payment on the certificate.

This produces an effect of preventing a more amount of payment than required and a fraudulent payment.

According to the mobile terminal in accordance with this invention, in a case where payment is shared by members of a group, the data acquisition unit calculates the amount of payment per person and transmits the amount of payment per person to other mobile terminals and acquires data for account settlement corresponding with the amount of payment per person from each of the other mobile terminals.

This produces an effect that even if each of members of the group does not make a request to go through the procedure of electronic account settlement, the representative of the group can make a request to go through the procedure of electronic account settlement in a collective manner.

According to the mobile terminal in accordance with this invention, when the data acquisition unit finishes acquiring the data for account settlement of all of the members to pay, an account settlement request unit transmits the data for account settlement of all of the members to pay to the POS terminal and makes a request to the POS terminal to go through the electronic account settlement for the banking agency.

This produces an effect that the procedure of electronic account settlement for the banking agency can be finished only by the representative of the group making a request to go through the procedure of electronic account settlement.

According to the mobile terminal in accordance with this invention, when the certificate preparation unit receives a notice of the amount of payment per person in a case where the payment is shared by members, the certificate preparation unit prepares a certificate of certifying the amount of payment per person to be an upper limit.

This produces an effect of preventing a more amount of payment than required.

According to a POS terminal in accordance with this invention, a bill data prepared by a bill data preparation unit is transmitted to the banking agency to go through the procedure of electronic account settlement. This produces an effect of simplifying the procedure of electronic account settlement.

According to the POS terminal in accordance with this invention, when the account settlement unit transmits the bill data prepared by the bill data preparation unit to the banking agency, the account settlement unit encrypts the bill data by use of a public key of the banking agency.

This produces an effect of ensuring the secrecy of the bill data.

According to the POS terminal in accordance with this invention, the bill data prepared by the bill data preparation unit is not transmitted to a banking agency at which a user has an account, but the bill data is transmitted to a banking agency with which a shop ties up and the tie-up banking agency goes through the procedure of electronic account settlement for the banking agency at which the user has an account.

This produces an effect of simplifying the processing of the Pos terminal.

According to the POS terminal in accordance with this invention, the bill data prepared by the bill data preparation unit is not transmitted to a banking agency at which a user has an account, but the bill data is transmitted to a communication terminal carrier and the communication terminal carrier draws the amount of bill as a communication rate from the banking agency at which the user has an account.

This produces an effect of simplifying the processing of the POS terminal.

### BRIEF DESCRIPTION OF THE DRAWINGS

FIG. 1 is a configurational view showing an electronic account settlement system in accordance with a first embodiment of this invention.

FIG. 2 is a configurational view showing a representative mobile terminal in accordance with the first embodiment of this invention.

FIG. 3 is a configurational view showing a member mobile terminal in accordance with the first embodiment of this invention.

FIG. 4 is a configurational view showing a POS terminal in accordance with the first embodiment of this invention.

FIG. 5 is a flow chart showing the procedures conducted by the representative mobile terminal.

FIG. 6 is a flow chart showing the procedures conducted by the member mobile terminal.

FIG. 7 is a flow chart showing the procedures conducted by the POS terminal.

FIG. 8 is an illustration to show data for account settlement.

FIG. 9 is an illustration to show bill data.

FIG. 10 is a configurational view showing an electronic account settlement system in accordance with a third embodiment of this invention.

FIG. 11 is an illustration to show bill data.

FIG. 12 is a configurational view showing an electronic account settlement system in accordance with a fourth embodiment of this invention.

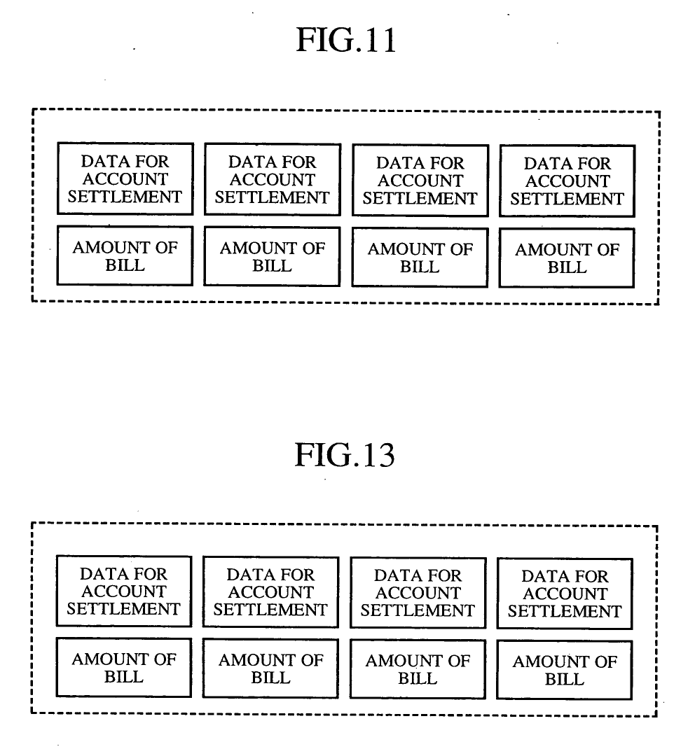

FIG. 11 is an illustration to show bill data.

### BEST MODE FOR CARRYING OUT THE INVENTION

In order to describe this invention in detail, the best modes for carrying out this invention will be hereinafter described with reference to the accompanying drawings.

### First Embodiment

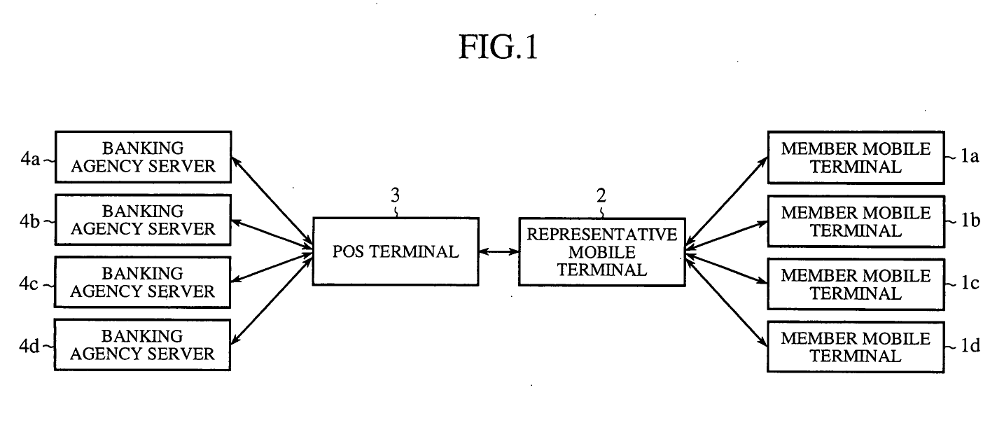

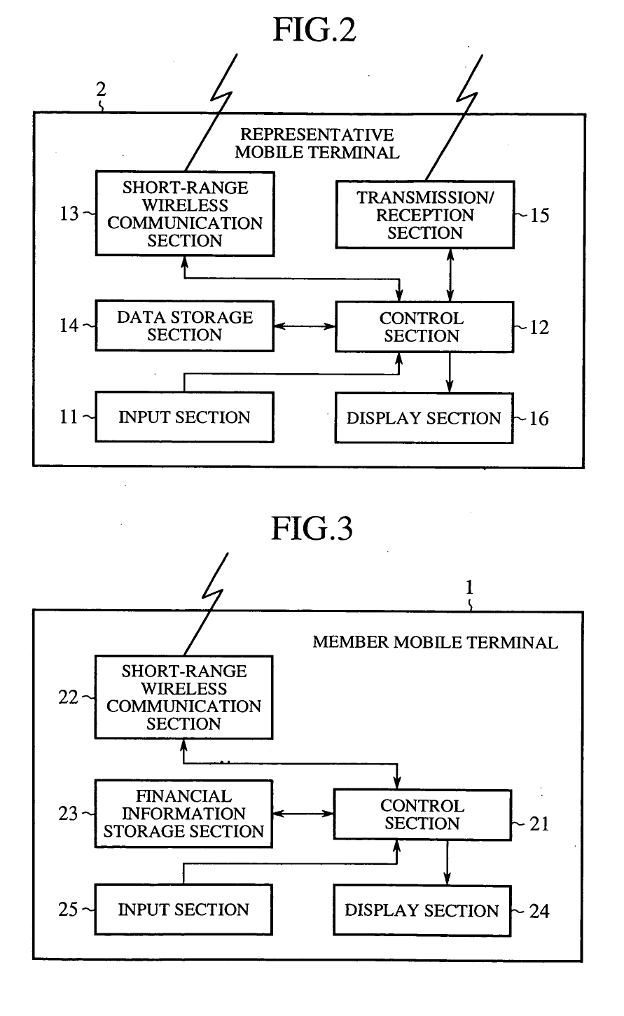

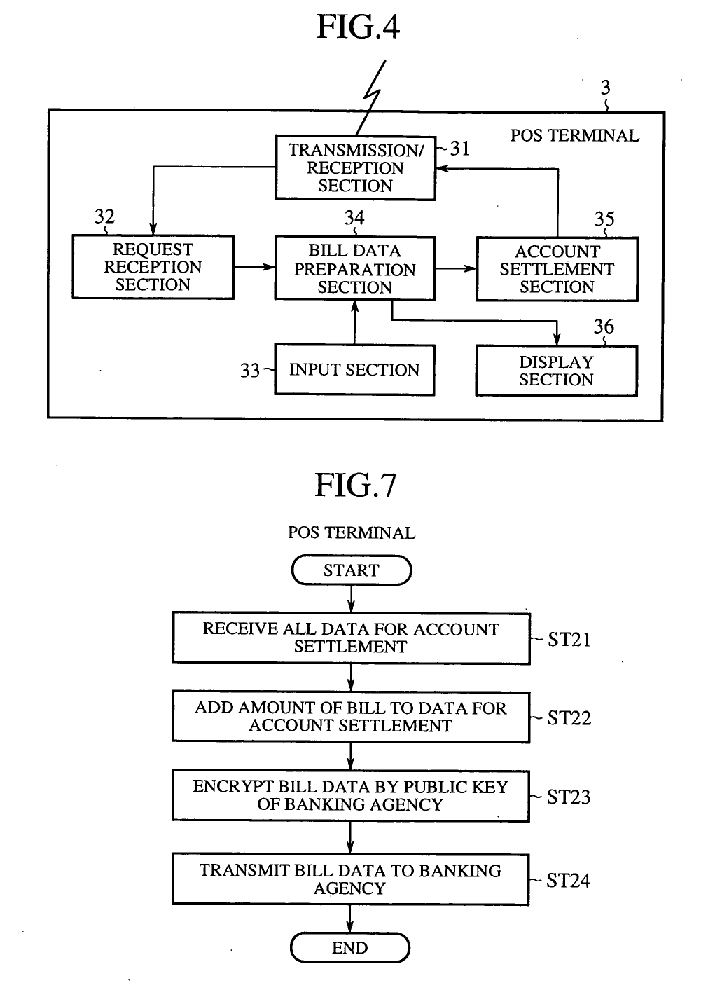

FIG. 1 is a configurational view showing an electronic account settlement system in accordance with the first embodiment of this invention. FIG. 2 is a configurational view showing a representative mobile terminal in accordance with the first embodiment of this invention. FIG. 3 is a configurational view showing a member mobile terminal in accordance with the first embodiment of this invention. Then, FIG. 4 is a configurational view showing a POS terminal in accordance with the first embodiment of this invention.

In the drawings, reference symbols 1a to 1d designate mobile terminals such as mobile phones used by members of a group to share a payment (hereinafter referred to as “member mobile terminals”), 2 designates a mobile terminal such as a mobile phone used by a representative of the group to share the payment (hereinafter referred to as “representative mobile terminal”), 3 designates a POS terminal set in a shop, and 4a to 4d designate servers of the banking agencies at which the members have their respective bank accounts (hereinafter referred to as “banking agency server”).

A reference symbol 11 designates an input section for inputting the amount of payment and the number of members to share the payment, 12 designates a control section that calculates the amount of payment per person and outputs an instruction of transmitting the amount of payment to the member mobile terminals 1a to 1d to a short-range wireless communication section 13, whereas when the short-range wireless communication section 13 receives data for account settlement corresponding with the amount of payment from each of the member mobile terminals 1a to 1d, it outputs to a transmission/reception section 15 an instruction of transmitting the data for account settlement to the POS terminal 3 so as to make a request to the POS terminal 3 to go through the procedures of electronic account settlement for the banking agencies, 13 designates a short-range wireless communication section such as Bluetooth, 14 designates a data storage section for temporarily storing the data for account settlement received by the short-range wireless communication section 13, 15 designates a transmission/reception section for making wireless communications with the POS terminal 3, and 16 designates a display section for displaying contents inputted to the input section 11, the amount of payment per person and so on.

Here, a data acquisition unit is constructed of the control section 12 and the short-range wireless communication section 13, whereas an account settlement request unit is constructed of the control section 12 and the transmission/reception section 15.

A reference symbol 21 designates a control section which, when a short-range wireless communication section 22 receives the amount of payment per person transmitted from the representative mobile terminal 2, prepares a certificate for allowing paying a bill, adds information relating to the banking agency at which the member has an account to the certificate, thereby to prepare data for account settlement, and outputs an instruction of transmitting the thus formed data for account settlement to the representative mobile terminal 2 to the short-range wireless communication section 22. A reference symbol 22 designates a short-range wireless section such as Bluetooth, 23 designates a financial information storage section for storing information relating to the banking agency at which the member has an account, 24 designates a display section for displaying the amount of payment per person and the like, and 25 designates an input section.

Here, a certificate preparation unit is constructed of the control section 21 and the financial information storage section 23, and a data supply unit is constructed of the control section 21 and the short-range wireless communication section 22.

A reference symbol 31 designates a transmission/reception section for conducting wireless communication with the representative mobile terminal 2 or the banking agency servers 4a to 4d, 32 designates a request reception section which, when the transmission/reception section 31 receives data for account settlement from the representative mobile terminal 2, receives a request to the banking agency servers 4a to 4d to go through a procedure of electronic account settlement, and 33 designates an input section for inputting the amount of bill and the like. Then, a reference symbol 34 designates a bill data preparation section that adds the amount of bill to the data for account settlement to prepare bill data, 35 designates an account settlement section that outputs an instruction of transmitting the bill data for the banking agency servers 4a to 4d to the transmission/reception section 31 to go through the procedure of electronic account settlement, and 36 designates a display section for displaying the amount of bill and the like.

Here, a request reception unit is constructed of the transmission/reception section 31 and the request reception section 32, a bill data preparation unit is constructed of the input section 33 and the bill data preparation section 34, and an account settlement unit is constructed of the transmission/reception section 31 and the account settlement section 35.

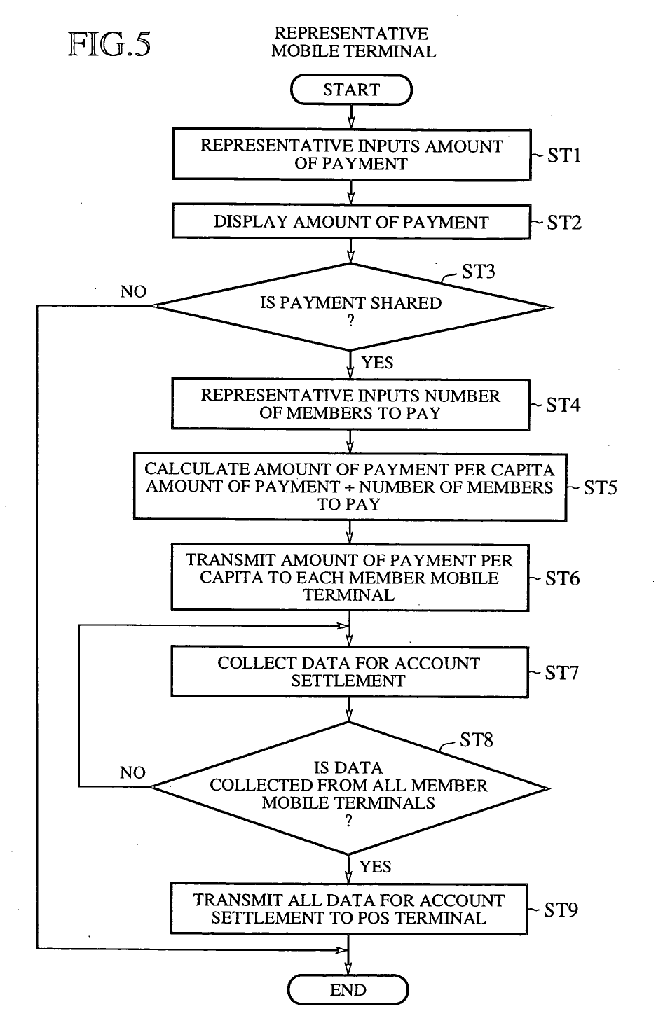

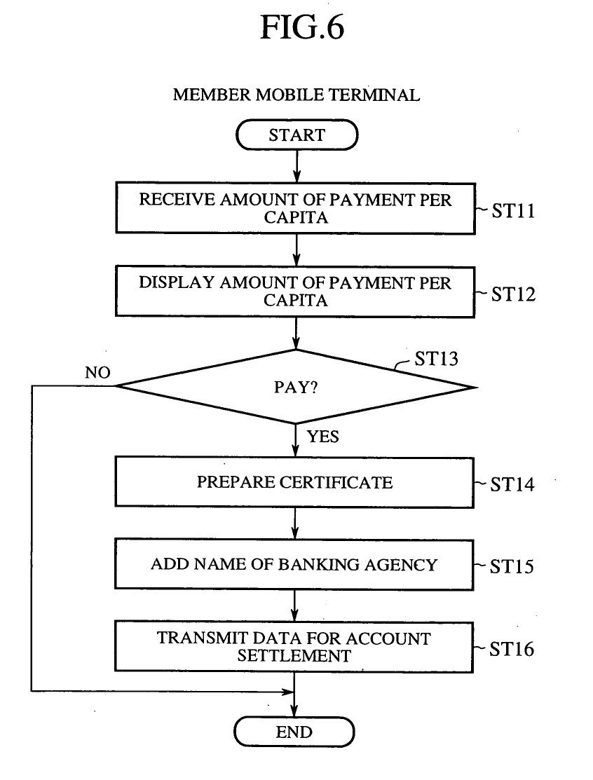

FIG. 5 is a flow chart showing the procedures conducted by the representative mobile terminal. FIG. 6 is a flow chart showing the procedures conducted by the member mobile terminal. FIG. 7 is a flow chart showing the procedures conducted by the POS terminal.

Next, operation will be described.

In this first embodiment, a case where a payment in a restaurant is shared by members of a group will be described by way of an example. First, when a representative of the members operates the input section 11 of the representative mobile terminal 2 to input the amount of payment (step ST1), the amount of payment is displayed on the display section 16 (step ST2). At this time, in a case where the payment is shared by the members, under an instruction from the control section 12, a message to the effect that the number of members to pay needs to be inputted is displayed.

When the representative of the members operates the input section 11 of the representative mobile terminal 2 to input the number of members to pay (step ST3 and step ST4), the control section 12 of the representative mobile terminal 2 divides the amount of payment by the number of members to pay to calculate the amount of payment per person (step ST5).

Then, the control section 12 of the representative mobile terminal 2 outputs an instruction of transmitting the amount of payment for the member mobile terminals 1a to 1d to the short-range wireless communication section 13 to inform the respective member mobile terminals of the amount of payment per person (step ST6).

When the short-range wireless transmission section 22 receives the amount of payment per person transmitted by the representative mobile terminal 2 (step ST11), the control section 21 of each of the member mobile terminals 1a to 1d displays the amount of payment on the display section 24 (step ST12) and displays a message to urge each member to select whether or not to allow the payment on the display section 24.

When a member of the group makes a selection to the effect that he allows the payment (step ST13), the control section 21 of each of the member mobile terminals 1a to 1d prepares a certificate to allow the payment (step ST14).

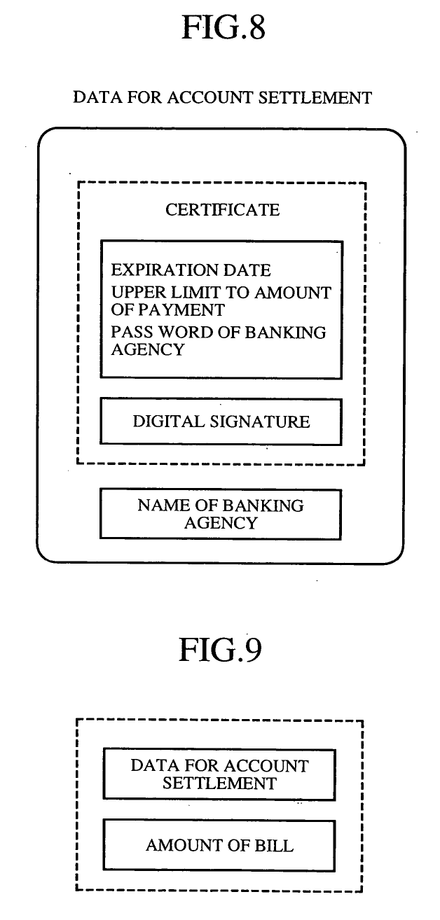

Here, in the certificate (for example, certificate of X509), as shown in FIG. 8, are described an upper limit to the amount of payment, an expiration date to allow payment, a pass word of the banking agency at which the member has an account, a digital signature of the member and so on. Usually, the upper limit to the amount of payment is set at the amount of payment per person.

Then, the control section 21 refers to the financial information storage section 23 and adds information relating to the banking agency at which the member has an account (for example, name of banking agency) to the certificate to prepare data for account settlement (step ST15) and then outputs an instruction of transmitting the data for account settlement for the representative mobile terminal 2 to the short-range wireless communication section 22 (step ST16).

The control section 12 of the representative mobile terminal 2 stores the data for account settlement in the data storage section 14 every time the short-range wireless communication section 13 receives the data for account settlement transmitted from the respective member mobile terminals. Here, in a case where also the representative is one of the members to share the payment, the control section 12 prepares the data for account settlement in the same way as the control section 21 of each of the member mobile terminals 1a to 1d and stores the data for account settlement in the data storage section 14.

Then, when the control section 12 collects the data for account settlement of all of the members to pay (steps ST7, ST8), it outputs an instruction of transmitting all of the data for account settlement for the POS terminal 3 to the transmission/reception section 15, thereby to make a request to the POS terminal to go through the procedure of electronic account settlement for the banking agency (step ST9).

When the transmission/reception section 31 receives the data for account settlement of all of the members to pay from the representative mobile terminal 2 (step ST21), the request reception section 32 of the POS terminal 3 receives a request of the procedure of electronic account settlement for the banking agency servers 4a to 4d and outputs the data for account settlement of all of the members to pay to the bill data preparation section 34.

The bill data preparation section 34 of the POS terminal 3, as shown in FIG. 9, adds the amount of bill (the amount of payment per person) to the data for account settlement outputted from the request reception section 32 to prepare the bill data (step ST22), and encrypts the bill data by use of the public key of the banking agency (step ST23).

Then, the account settlement section 35 of the POS terminal 3 outputs an instruction of transmitting the encrypted bill data for the banking agency servers 4a to 4d to the transmission/reception section 31 to go through the procedure of electronic account settlement (step ST24).

When each of the banking agency servers 4a to 4d receives the encrypted bill data from the POS terminal 3, it decrypts the bill data and collects the amount of bill from the bank account of each of the members according to the decrypted bill data, thereby to electronically settle accounts.

As is clear from the above description, according to this first embodiment, in a case where the payment is shared by the members, the amount of payment per person is calculated and is transmitted to the member mobile terminals 1a to 1d and the data for account settlement corresponding with the amount of payment is acquired from the member mobile terminals 1a to 1d. Thus, it is possible to produce an effect that even if each of the members of the group does not make a request to go through the procedure of electronic account settlement, the representative of the group can make a request to go through the procedure of electronic account settlement in a collective manner.

### Second Embodiment

While a case where the payment is shared by the members, that is, a case where the representative and members of the group pay together has been described in the first embodiment described above, it is also recommended that when a member buys goods, the representative makes a request to go through the procedure of electronic account settlement in place of the member.

To be more specific, in a case where a member having a member mobile terminal 1a wants to buy some goods, when the representative having the representative mobile terminal 2 goes to, for example, a department store in a distant place on business, the member operates the input section 25 of the member mobile terminal 1a to supply the representative mobile terminal 2 with the account settlement data in which the purchase price of the goods is described.

Then, when the representative buys the goods at the department store, he transmits the account settlement data supplied by the member mobile terminal 1a to the POS terminal 3 at the department store to make a request to go through the procedure of electronic account settlement.

Through this operation, the bill of the goods is collected from the member's bank account to electronically settle accounts. Thus, according to this second embodiment, it is possible to offer a person a convenience of making a request to his friend to buy some goods, for example, and hence for the person to buy some goods even if the person himself does not go to the department store or the like in a distant place.

### Third Embodiment

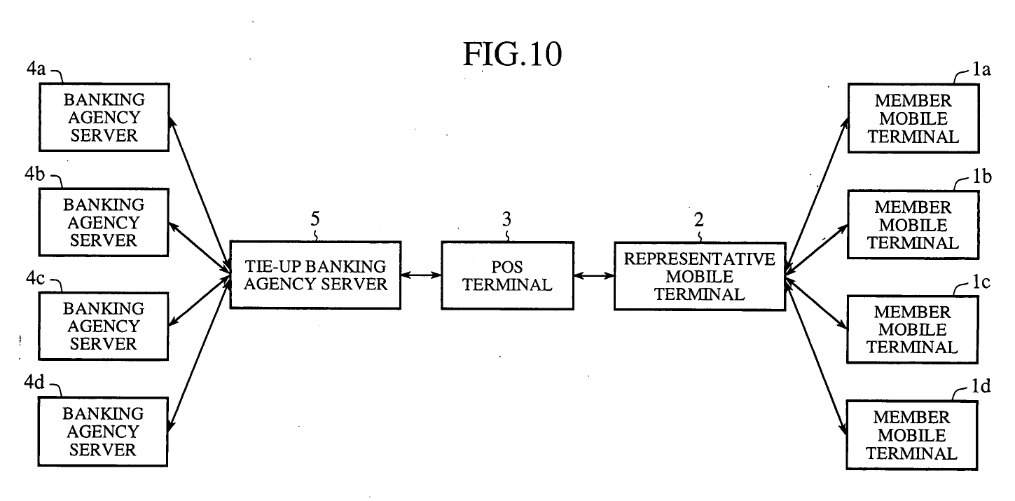

It has been described in the above-described first embodiment as to the case where the POS terminal 3 transmits the encrypted bill data to the servers 4a to 4d of the banking agencies at which the members have their accounts. As shown in FIG. 10, however, it is also recommended that the POS terminal 3 transmits the bill data of all of the members to pay to the banking agency server 5 with which the shop ties up (hereinafter referred to as “tie-up banking agency server”) (see FIG. 11) and that in place of the POS terminal 3, the tie-up banking agency server 5 goes through the procedure of electronic account settlement for the servers 4a to 4d of the banking agencies at which the members have their accounts.

In this regard, the bill data transmitted by the POS terminal 3 is encrypted by the public key of the tie-up banking agency and then is transmitted to the tie-up banking agency.

### Fourth Embodiment

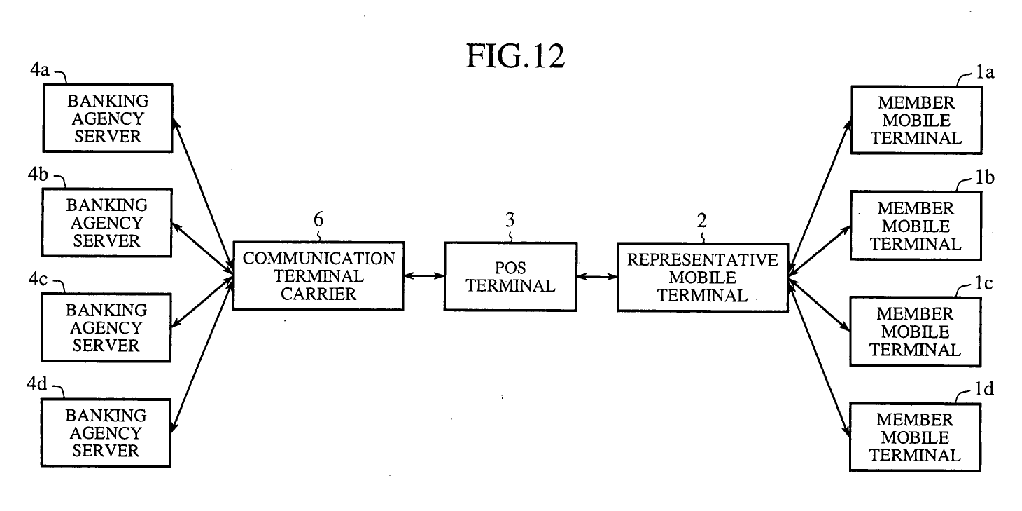

In the third embodiment, it has been described as to the case where the POS terminal 3 transmits the bill data of all of the members to pay to the tie-up banking agency server 5 of the shop, and in place of the POS terminal 3, the tie-up banking agency server 5 goes through the procedure of electronic account settlement for the servers 4a to 4d of the banking agencies at which the members have their accounts. As shown in FIG. 12, however, it is also recommended that the POS terminal 3 transmits the bill data of all of the members to pay to the server 6 of a communication terminal carrier (hereinafter referred to as “communication carrier server”) in a collective manner (see FIG. 13) and that the communication terminal carrier sever 6 draws out the amount of bill as a communication rate from the servers 4a to 4d of the banking agencies at which the members have their accounts.

In this regard, the bill data transmitted from the POS terminal 3 is encrypted by the public key of the communication terminal carrier and then is transmitted to the communication terminal carrier.

### Industrial Applicability

As described above, for example, when payment is shared by the members of a group, even if the respective members of the group do not make a request to go through the procedure of electronic account settlement on an individual basis, the mobile terminal and the POS terminal in accordance with this invention make it possible for the representative of the group to make a request to go through the procedure of electronic account settlement in a collective manner. Thus, mobile terminals and a POS terminal according to this invention are suitable for the procedure of electronic account settlement that needs to be simplified in operation.

What is claimed is:

1. A mobile terminal comprising:
a data acquisition unit for acquiring such data for account settlement that includes a certificate to allow payment and information relating to a banking agency to do business with; and
an account settlement request unit that transmits the data for account settlement acquired by the data acquisition unit to a POS terminal and makes a request to the POS terminal to go through a procedure of electronic account settlement for the banking agency.

2. The mobile terminal according to claim 1, wherein the data acquisition unit is provided with a short-range wireless communication function of receiving the data for account settlement from other mobile terminals.

3. A mobile terminal comprising:
a certificate preparation unit for preparing a certificate of allowing payment; and
a data supply unit that adds information relating to a banking agency to do business with to the certificate prepared by the certificate preparation unit so as to prepare data for account settlement, and supplies the data for account settlement to other mobile terminals.

4. The mobile terminal according to claim 3, wherein the data supply unit has a short-range wireless communication function of transmitting the data for account settlement to other mobile terminals.

5. The mobile terminal according to claim 3, wherein the certificate preparation unit describes an upper limit to the amount of payment and an expiration date to allow the payment on the certificate.

6. The mobile terminal according to claim 1, wherein in a case where the payment is shared by members, the data acquisition unit calculates the amount of payment per person and transmits the amount of payment per person to other mobile terminals and acquires data for account settlement corresponding with the amount of payment from each of the other mobile terminals.

7. The mobile terminal according to claim 6, wherein when the data acquisition unit finishes acquiring the data for account settlement of all of the members to pay, the account settlement request unit transmits the data for account settlement of all of the members to pay to the POS terminal and makes a request to the POS terminal to go through the procedure of electronic account settlement for the banking agency.

8. The mobile terminal according to claim 5, wherein when the certificate preparation unit receives a notice of the amount of payment per person in a case where the payment is shared by members, the certificate preparation unit prepares a certificate of certifying the amount of payment to be an upper limit.

9. A POS terminal comprising:
a request reception unit that receives data for account settlement including a certificate of allowing payment and information relating to a banking agency to do business with and receives a request to go through a procedure of electronic account settlement for the banking agency from a mobile terminal;
a bill data preparation unit that adds the amount of bill to the data for account settlement received by the request reception unit so as to prepare bill data; and
an account settlement unit that transmits the bill data prepared by the bill data preparation unit to the banking agency to go through the procedure of electronic account settlement.

10. The POS terminal according to claim 9, wherein when the account settlement unit transmits the bill data prepared by the bill data preparation unit to the banking agency, the account settlement unit encrypts the bill data by the use of a public key of the banking agency.

11. The POS terminal according to claim 9, wherein the account settlement unit does not transmit the bill data prepared by the bill data preparation unit to a banking agency at which a user has an account, but transmits the bill data to a banking agency with which a shop ties up, and the tie-up banking agency goes through the procedure of electronic account settlement for the banking agency at which the user has an account.

12. The POS terminal according to claim 9, wherein the account settlement unit does not transmit the bill data prepared by the bill data preparation unit to a banking agency at which a user has an account, but transmits the bill data to a communication terminal carrier, and the communication terminal carrier draws out the amount of bill as a communication rate from the banking agency at which the user has an account.
